(19) United States
(12) Patent Application Publication
(10) Pub. No.: US 2004/0240691 A1
(43) Pub. Date: Dec. 2, 2004

(54) Securing a hearing aid or an otoplastic in the ear

(76) Inventor: Esfandiar Grafenberg, Hausen (DE)

Correspondence Address: SCHIFF HARDIN, LLP, PATENT DEPARTMENT, 6600 SEARS TOWER, CHICAGO, IL, 60606-6473, US

(21) Appl. No.: 10/841,612

(22) Filed: May 7, 2004

(30) Foreign Application Priority Data
May 9, 2003 (DE) 103 20 863.1

(51) Int. Cl. H04R 25/00

(52) U.S. Cl. 381/312; 381/328; 381/322

(57) ABSTRACT

In an in-the-ear hearing aid, or a hearing aid with an in-the-ear otoplastic, a first magnetic or magnetizable element is arranged in or on the housing of the hearing air or, respectively, in or on the otoplastic. This element interacts with a second magnetic or magnetizable element arranged behind the ear or, respectively, implanted in the ear, so that the force of attraction of the two magnetic or magnetizable elements provides an additional holding and fixing of the hearing aid or the otoplastic, respectively, in the ear.

### BACKGROUND OF THE INVENTION

In the field of hearing aids, a distinction is made between in-the-ear hearing aids and behind-the-ear hearing aids. The latter are held on a support hook behind the ear, and only an otoplastic is located in the ear, this otoplastic protruding fully or partially into the auditory canal and having a sound tube routed through it. In the case of in-the-ear hearing aids, a further distinction is made between full-concha devices, whose housing lies for the most part in the concha of the outer ear when the hearing aid is fitted, and half-concha devices and auditory canal devices whose housing disappears completely or almost completely in the auditory canal of the ear when the hearing aid is fitted.

A good signal transmission through the respective hearing aid can be achieved only if the in-the-ear hearing aid or the in-the-ear otoplastic is situated in the position intended for it in the auditory canal. However, the hearing aid or otoplastic often slips out of the intended position, with the result that optimal functioning of the hearing aid is no longer ensured. In the least favorable scenario, the hearing aid or otoplastic may even slip out completely and may then be lost. Difficulties in keeping the hearing aid or otoplastic in the position intended for it often occur especially in infants and children, and in patients with very narrow or very wide auditory canals. In addition, infants and young children are not able to manually correct a hearing aid which has slipped from the optimal position or an otoplastic which is not arranged in an optimal position.

To fix hearing aids or otoplastics in hearing aid wearers who are not able to correct an unfavorable position of the hearing aids or otoplastics, additional mechanisms such as a headband, adhesive tapes or headphone bracket are normally used to fix the hearing aids or otoplastics.

German patent document DE 298 20 193 U1 discloses a behind-the-ear hearing aid with support hook, in which a holder part connectable to the hearing aid is provided which, in order to improve the hold of the hearing aid on the ear, engages in the side of the auricle directed away from the head.

U.S. Pat. No. 4,756,312 discloses a magnetic device with which a hearing aid can be fitted into an auditory canal or removed therefrom. For this purpose, the magnetic force of attraction, which acts on a pin, can be adjusted by way of a turning device.

German patent document DE 197 56 992 A1 discloses a hearing aid which has a recess for receiving a battery. This recess is provided at its base with a pole designed as a permanent magnet. The jacket of a battery element for this hearing aid is made of a magnetic material, so that the battery is held permanently in the recess.

### SUMMARY OF THE INVENTION

It is an object of the present invention to provide a way for the fixing, in the ear, of a hearing aid worn in an auditory canal or of the otoplastic, worn in an auditory canal, of a behind-the-ear hearing aid.

In an in-the-ear hearing aid with a housing, or a hearing aid with an in-the-ear otoplastic, this object is achieved by a first magnetic or magnetizable element arranged in or on the housing or in or on the otoplastic, and a second magnetic or magnetizable element arranged behind the ear or implanted in the ear, which element interacts with the first magnetic or magnetizable element to hold or fix the housing or the otoplastic in the ear.

According to the invention, at least the first or the second magnetic or magnetizable element is designed as a permanent magnet. The respective other magnetic or magnetizable element can either be designed likewise as a permanent magnet or can comprise at least a magnetizable material. By way of the magnetic force arising between the first magnetic or magnetizable element and the second magnetic or magnetizable element, the in-the-ear hearing aid or the otoplastic is held and fixed in the desired position in the ear.

According to various embodiments of the invention, the first magnetic or magnetizable element is in this case arranged in or on the in-the-ear hearing aid or in or on the otoplastic. The second magnetic or magnetizable element can, for example, be arranged behind the ear. However, it can also be implanted in the ear, preferably in an area near the auditory canal inlet. In the last-mentioned case, the second magnetic or magnetizable element is to be provided with a biocompatible covering so as to avoid its being rejected by the body of the person wearing the hearing aid.

In a preferred embodiment with a behind-the-ear hearing aid and an in-the-ear otoplastic, the first magnetic or magnetizable element is arranged in the otoplastic, and the second magnetic or magnetizable element is arranged in the behind-the-ear hearing aid. As a result, when looking at a hearing aid of this kind according to the invention from the outside, there is no apparent difference from a conventional behind-the-ear hearing aid.

Via the invention, the in-the-ear hearing aid, or the otoplastic of a behind-the-ear hearing aid, is fixed in the desired position in the auditory canal. In this way, the best possible sound transmission through the hearing aid is ensured. Particularly in hearing aid wearers who are not able to manually correct an unfavorable position of the hearing aid or otoplastic, it is no longer necessary to use additional and inadequate assistance mechanism such as adhesive tape, headphone bracket or headband as an emergency solution. A hearing aid according to the invention thus remains in the intended position, even, for example, in the event of sporadic head movements of a small child.

### DESCRIPTION OF THE DRAWINGS

Further details and advantages of the invention are explained below on the basis of illustrative embodiments shown in the drawings.

FIG. 1 is a sectional (top) view showing a behind-the-ear hearing aid with an otoplastic and two permanent magnets;

FIG. 2 is a sectional (top) view showing a further behind-the-ear hearing aid with an otoplastic and two permanent magnets;

FIG. 3 is a sectional (top) view showing an in-the-ear hearing aid with a permanent magnet and an implanted permanent magnet; and

FIG. 4 is a sectional (top) view showing a further in-the-ear hearing aid with a permanent magnet and an implanted permanent magnet.

### DETAILED DESCRIPTION OF THE PREFERRED EMBODIMENTS

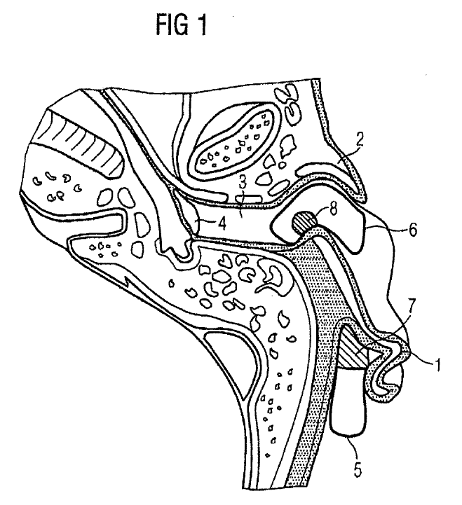

FIG. 1 shows a sectional view through the ear, the direction of view being from the top of the head downward. The view shows, in particular, the outer ear 1, the tragus 2, the auditory canal 3 and the eardrum 4. A behind-the-ear hearing aid 5 is arranged on the ear with an otoplastic 6 worn almost completely in the auditory canal 3.

In FIG. 1, the otoplastic 6 is situated in the optimal position provided for it in the auditory canal 3. To fix the otoplastic 6 in this intended position, permanent magnets 7 and 8 are provided in the hearing aid 5 and in the otoplastic 6, respectively, these permanent magnets being oriented in such a way that they mutually attract. Via the magnetic force of attraction, the otoplastic 6 is fixed in the position intended for it in the auditory canal 3. In this way, the otoplastic 6 remains in the intended position even in the event of rapid head movements.

Since the permanent magnets 7 and 8 cannot be seen from outside, the hearing aid 5 cannot be differentiated externally from a conventional hearing aid. The hearing aid 5 is also fitted and removed in the same way as a conventional hearing aid. The hearing aid 5 shown is therefore also extremely suitable for use in infants and young children.

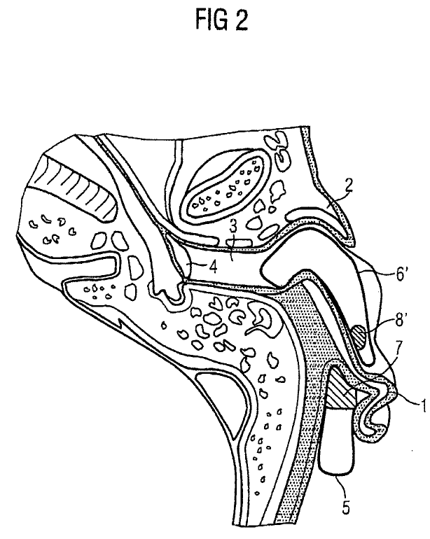

Like FIG. 1, FIG. 2 also shows a behind-the-ear hearing aid 5 with an otoplastic 6′. In contrast to FIG. 1, however, only a small part of the otoplastic 6′ in FIG. 2 is situated within the auditory canal 3. The greater part of the otoplastic 6′ lies in the concha of the outer ear 1. In contrast to FIG. 1, the permanent magnet 8′ for holding and fixing the otoplastic 6′ is also not situated in the subarea of the otoplastic 6′ protruding into the auditory canal 3. However, in this embodiment too, the permanent magnets 7 and 8′ also ensure additional holding and fixing of the otoplastic 6′ in the ear. Also, the otoplastic 6′ therefore no longer slips inadvertently from the optimal position intended for it.

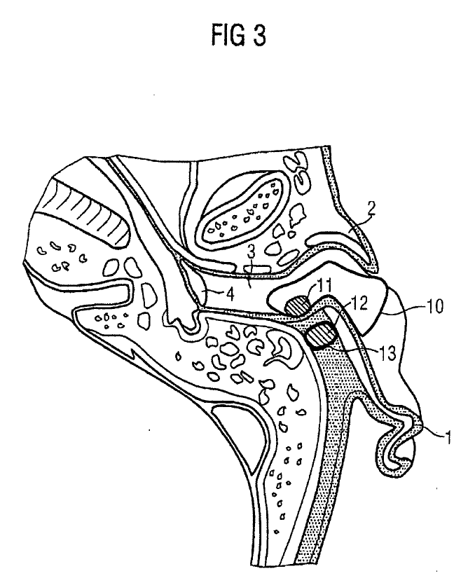

A further illustrative embodiment of the invention is shown in FIG. 3. The cross-sectional view of the ear corresponds to the view according to FIG. 1. In contrast to FIG. 1, however, an in-the-ear hearing aid 10 is situated in the auditory canal 3 in the illustrative embodiment according to FIG. 3. This hearing aid too comprises, according to the invention, a magnetic or magnetizable element arranged inside the hearing aid housing, preferably a permanent magnet 11. In the illustrative embodiment, the latter interacts with a second magnetic or magnetizable element, for example a permanent magnet 12. In this illustrative embodiment too, the magnetic poles are oriented in such a way that the permanent magnets 11 and 12 mutually attract. Via the magnetic attraction force thus exerted, the in-the-ear hearing aid 10 is secured and fixed in the auditory canal 3.

In further contrast to the illustrative embodiment according to FIG. 1, the permanent magnet 12 in FIG. 3 is not situated behind the outer ear 1, but instead implanted beneath the skin in an area near the auditory canal 3. Such implantation is particularly recommended if, because of the hearing loss in the hearing aid wearer, an operation is required anyway. To avoid rejection by the body, the permanent magnet 12 is advantageously surrounded by a covering 13 of biocompatible material.

This illustrative embodiment also affords the advantage that the in-the-ear hearing aid 10 according to various embodiments of the invention cannot be distinguished from a conventional in-the-ear hearing aid. The permanent magnet 12, by being implanted, also cannot be seen from the outside. The cosmetic advantages of an in-the-ear hearing aid are accordingly maintained, and the handling of the in-the-ear hearing aid 10, in particular its fitting and removal, is no different from that of a conventional hearing aid. Nevertheless, the securing and fixing of the hearing aid 10 according to the invention is considerably improved by comparison with a conventional in-the-ear hearing aid.

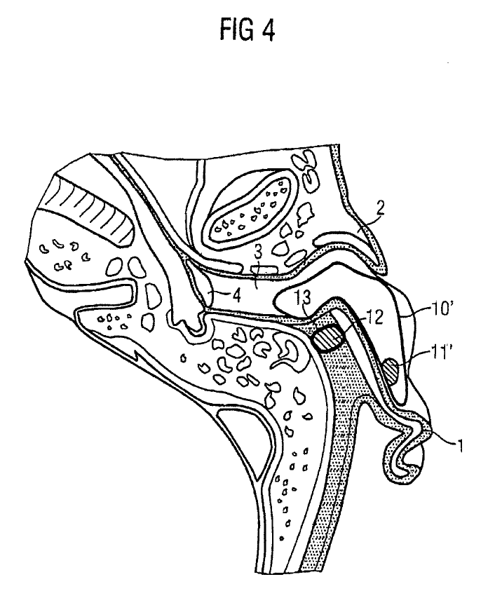

A variation of the illustrative embodiment according to FIG. 3 is shown in FIG. 4. In contrast to FIG. 3, a full-concha device 10′ is situated in the ear of the hearing aid wearer. In this illustrative embodiment, a permanent magnet 11′ is arranged in the subarea of the housing of the full-concha device 10′ which lies in the concha of the outer ear 1. With appropriate orientation of the permanent magnets 11′ and 12, the resulting force of attraction between the magnets in this case too provides additional securing and fixing of the full-concha device 10′ in the ear.

In contrast to the illustrative embodiments, it is not strictly necessary to have two magnetic elements designed as permanent magnets 7, 8 and 7, 8′ or 11, 12 and 11′ 12. Instead, it suffices if one magnetic element designed as a permanent magnet interacts with a magnetizable element which is made essentially of a magnetizable material such as iron, cobalt or nickel. In addition, in the case of an in-the-ear hearing aid too, the second magnetic or magnetizable element can be arranged behind the ear. This element is fixed behind the ear by the magnetic force alone, for example, or by an additional retaining element, for example a retaining bracket. Moreover, the second magnetic or magnetizable element 12 can also be implanted in the ear at a site other than that shown, for example also in the area of the outer ear.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A hearing aid device that is an in-the-ear hearing aid with a housing, or a hearing aid with an in-the-ear otoplastic, comprising:
a first magnetic or magnetizable element arranged in or on the housing or, respectively, in or on the otoplastic; and
a second magnetic or magnetizable element arranged behind the ear or, respectively, implanted in the ear, which element interacts with the first magnetic or magnetizable element to hold or fix the housing or the otoplastic in the ear.

2. The hearing aid as claimed in claim 1, wherein the housing of the hearing aid or the otoplastic protrudes at least partially into the auditory canal of the ear, the first magnetic or magnetizable element being arranged in or on a subarea of the housing or the otoplastic protruding into the auditory canal.

3. The hearing aid as claimed in claim 1, wherein the housing of the hearing aid or the otoplastic is arranged at least partially in the concha of the ear, and the first magnetic or magnetizable element is arranged in or on a subarea of the housing or the otoplastic lying in the concha.

4. The hearing aid as claimed in claim 1, wherein the second magnetic or magnetizable element is provided with a biocompatible covering.

5. The hearing aid as claimed in claim 1, wherein the first magnetic or magnetizable element is arranged in or on the otoplastic, and the second magnetic or magnetizable element is arranged in or on the housing of the behind-the-ear hearing aid.
